(19) United States
(12) Patent Application Publication
(10) Pub. No.: US 2013/0078546 A1
(43) Pub. Date: Mar. 28, 2013

(54) SOLID OXIDE FUEL CELL AND SOLID OXIDE FUEL CELL MODULE

(71) Applicants: Sung Han KIM, Seoul (KR); Jong Ho CHUNG, Gyunggi-do (KR); Eon Soo LEE, Gyeongsangbuk (KR); Jong Sik YOON, Gyunggi-do (KR)

(72) Inventors: Sung Han KIM, Seoul (KR); Jong Ho CHUNG, Gyunggi-do (KR); Eon Soo LEE, Gyeongsangbuk (KR); Jong Sik YOON, Gyunggi-do (KR)

(73) Assignee: SAMSUNG ELECTRO-MECHANICS CO., LTD., Gyunggi-do (KR)

(21) Appl. No.: 13/340,932

(22) Filed: Dec. 30, 2011

(30) Foreign Application Priority Data
Sep. 27, 2011 (KR) 10-2011-0097726

(51) Int. Cl. H01M 8/24; H01M 8/12

(52) U.S. Cl. 429/466; 429/488

(57) ABSTRACT

Disclosed herein are a solid oxide fuel cell and a solid oxide fuel cell module. The solid oxide fuel cell includes: a unit cell including an anode, an electrolyte formed to surround the outer circumference of the anode and having a first opening part exposing the anode in a longitudinal direction, a cathode formed to surround the outer circumference of the electrolyte and having a second opening part corresponding to the first opening part, and a connector formed to cover the first opening part; a first current collecting member formed to be contacted with the anode; an insulating member formed to cover the first current collecting member; a second current collecting member formed to be contacted with the cathode; and a fixing unit integrating and fixing the first current collecting member, the insulating member, and the second current collecting member with the unit cell.

### CROSS REFERENCE TO RELATED APPLICATION

This application claims the benefit of Korean Patent Application No. 10-2011-0097726, filed on Sep. 27, 2011, entitled “Solid Oxide Fuel Cell and Solid Oxide Fuel Cell Module”, which is hereby incorporated by reference in its entirety into this application.

### BACKGROUND OF THE INVENTION

1. Technical Field

The present invention relates to a solid oxide fuel cell and a solid oxide fuel cell module.

2. Description of the Related Art

A fuel cell is an apparatus that directly converts chemical energy of fuel (hydrogen, LNG, LPG, or the like) and air (oxygen) into electricity and heat by electrochemical reaction. The electricity generation technology of the prior art has been developed by passing through procedures of fuel combustion, steam generation, turbine driving, generator driving, and the like. However, the fuel cell does not require fuel combustion or turbine, resulting in high efficiency and few environmental problems, and thus, it is a new concept of electricity generation technology.

The fuel cell barely discharges air pollutants such as SO_{N}, NO_{R}, or the like, and generate less carbon dioxide, so that it can implement chemical-free, low-noise, non-vibration generation, or the like.

There are various types of fuel cells, such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC), and the like. Among them, the solid oxide fuel cell (SOFC) allows high-efficiency generation, and coal gas-fuel cell-gas turbine hybrid generation, and produces various power capacities, with the result that it is suitable for small-sized or large-sized generating plants or distributed power sources. Therefore, the solid oxide fuel cell is an essential generation technology in order to enter a hydrogen economy society in the future.

On the other hand, the solid oxide fuel cell may be largely divided into a flat plate type and a tube type.

In the prior art, a flat plate type solid oxide fuel cell is disclosed in Korean Patent No. 0341402, and a tube type, in particular a cylindrical type solid oxide fuel cell is disclosed in Korean Patent No. 0344936.

The flat plate type solid oxide fuel cell according to the prior art has an advantage in that the manufacturing cost is low. The flat plate type solid oxide fuel cell requires a high-temperature seal in order to prevent air or gas from leaking when unit cells thereof are stacked. However, as for this seal, long-period durability is not stable and crack occurs due to thermal impact.

Further, the tube type solid oxide fuel cell according to the prior art requires no seals, unlike the flat plate type solid oxide fuel cell, resulting in long-period durability and stability against thermal impact. However, when unit cells thereof are stacked, a large volume is required, and thus, output density per volume becomes relatively low.

### SUMMARY OF THE INVENTION

The present invention has been made in an effort to provide a solid oxide fuel cell and a solid oxide fuel cell module, capable of having stability against thermal impact and high output.

Further, the present invention has been made in an effort to provide a solid oxide fuel cell and a solid oxide fuel cell module in which both current-collecting by an anode positioned inside and current-collecting by a cathode positioned outside are possible from the outside.

Further, the present invention has been made in an effort to provide a solid oxide fuel cell and a solid oxide fuel cell module, capable of facilitating serial connection and parallel connection between unit cells.

According to a preferred embodiment of the present invention, there is provided a solid oxide fuel cell, including: a unit cell including an anode, an electrolyte formed to surround the outer circumference of the anode and having a first opening part exposing the anode in a longitudinal direction, a cathode formed to surround the outer circumference of the electrolyte and having a second opening part corresponding to the first opening part, and a connector formed to cover the first opening part; a first current collecting member formed to be contacted with the connector to thereby collect current of the anode; an insulating member formed to cover the first current collecting member; a second current collecting member formed to be contacted with the cathode to thereby collect current of the cathode; and a fixing unit integrating and fixing the first current collecting member, the insulating member, and the second current collecting member with the unit cell.

The insulating member may be made of ceramics.

The solid oxide fuel may further include a barrier layer formed between the anode and the connector.

The barrier layer may be made of stainless steel (SUS).

The first current collecting member and the second current collecting member may be in a metal strip type.

The metal may be silver (Ag).

The solid oxide may further include a mesh type conductive member and a conductive paste layer formed between the connector and the first current collecting member.

The solid oxide fuel cell may further include a mesh type conductive member and a conductive paste layer formed between the cathode and the second current collecting member.

The fixing unit may be a wire, and the wire may be made of silver (Ag).

According to another preferred embodiment of the present invention, there is provided a solid oxide fuel cell module, including: a unit cell including an anode, an electrolyte formed to surround the outer circumference of the anode and having a first opening part exposing the anode in a longitudinal direction, a cathode formed to surround the outer circumference of the electrolyte and having a second opening part corresponding to the first opening part, and a connector formed to cover the first opening part; a first current collecting member formed to be contacted with the connector to thereby collect current of the anode; an insulating member formed to cover the first current collecting member; a second current collecting member formed to be contacted with the cathode to thereby collect current of the cathode; a fixing unit integrating and fixing the first current collecting member, the insulating member, and the second current collecting member with the unit cell; and a connecting member connecting a plurality of unit cells.

The connecting member may connect a first current collecting member and a second current collecting member of one solid oxide fuel cell module of the plurality of solid oxide fuel cells to a second current collecting member and a first current collecting member of another solid oxide fuel cell module of the plurality of solid oxide fuel cell, respectively.

The connecting member may connect a first current collecting member and a second current collecting member of one solid oxide fuel cell module of the plurality of solid oxide fuel cells to a first current collecting member and a second current collecting member of another solid oxide fuel cell module of the plurality of solid oxide fuel cell, respectively.

The insulating member may be made of ceramics.

The solid oxide fuel cell module may further include a barrier layer formed between the anode and the connector.

The barrier layer may be made of stainless steel (SUS).

The first current collecting member and the second current collecting member may be in a metal strip type, and the metal may be silver (Ag).

The fixing unit may be a wire, and the wire may be made of silver (Ag).

### BRIEF DESCRIPTION OF THE DRAWINGS

FIG. 1 is a perspective view showing a structure of a unit cell of a solid oxide fuel cell according to one preferred embodiment of the present invention;

FIG. 2 is a perspective view showing a structure of the solid oxide fuel cell according to the preferred embodiment of the present invention;

FIG. 3 is a cross-sectional view taken along line A-A′ of the solid oxide fuel cell according to the preferred embodiment of the present invention;

FIG. 4 is a perspective view showing a structure of a solid oxide fuel cell module in which solid oxide fuel cells are connected in series, according to another preferred embodiment of the present invention;

FIG. 5 is a plan view showing the solid oxide fuel cell module shown in FIG. 4;

FIG. 6 is a perspective view showing a structure of a solid oxide fuel cell module in which solid oxide fuel cells are connected in parallel, according to another preferred embodiment of the present invention; and

FIG. 7 is a plan view showing the solid oxide fuel cell module shown in FIG. 6.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description and preferred embodiments taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first”, “second”, and so on are used to distinguish one element from another element, and the elements are not defined by the above terms.

Hereinafter, preferred embodiments of the present invention will be described in detail with reference to the accompanying drawings.

Solid Oxide Fuel Cell

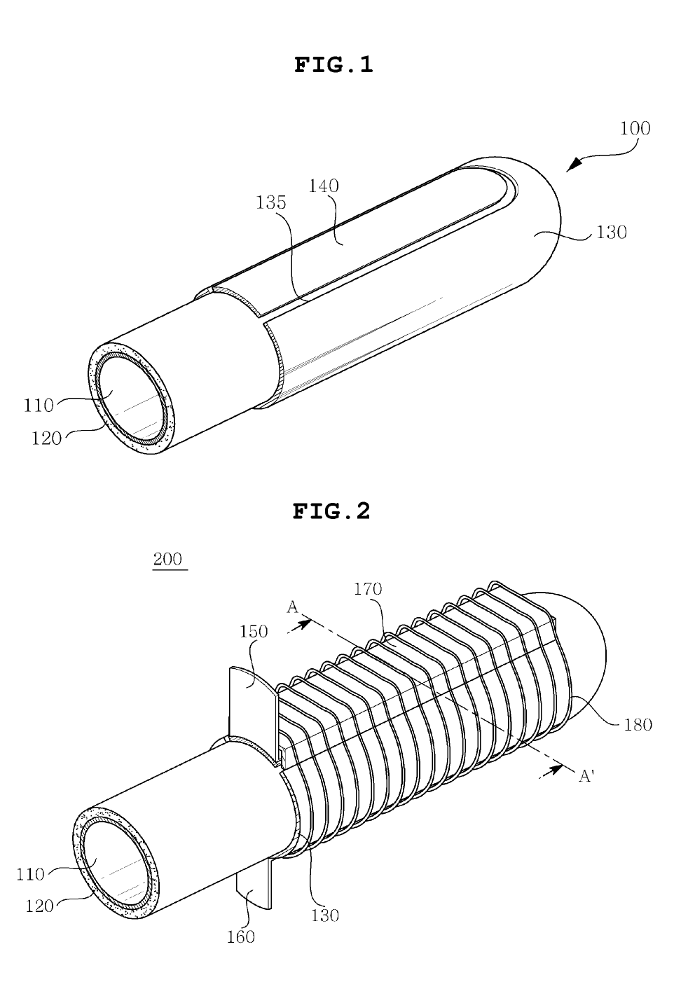

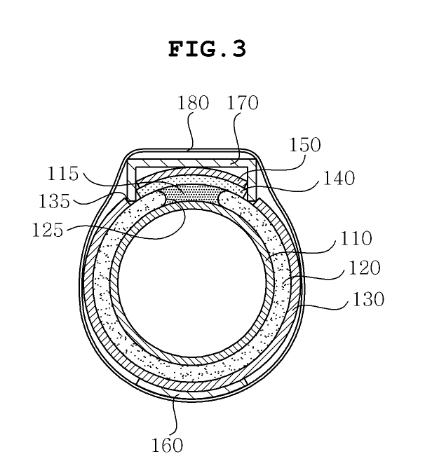

FIG. 1 is a perspective view showing a structure of a unit cell of a solid oxide fuel cell according to one preferred embodiment of the present invention, FIG. 2 is a perspective view showing a structure of the solid oxide fuel cell according to the preferred embodiment of the present invention, and FIG. 3 is a cross-sectional view taken along line A-A′ of the solid oxide fuel cell according to the preferred embodiment of the present invention.

Referring to FIGS. 1 and 2, a solid oxide fuel cell 200 according to one preferred embodiment of the present invention includes a unit cell 100, a first current collecting member 150, a second current collecting member 160, and a fixing unit 180.

The unit cell 100 is a basic unit for producing electric energy, and may include an anode 110, an electrolyte 120, a cathode 130, and a connector 140. Respective constituents of the unit cell 100 will be described below.

The anode 110 functions to support the electrolyte 120 and the cathode 130, which surround the outer circumference of the anode 110.

For this reason, the anode 110 may be relatively thicker than the electrolyte 120 and the cathode 130 so as to secure a support force and may be formed through an injection molding process, but is not limited thereto.

In addition, as shown in FIG. 1, the anode 110 is formed in a cylindrical shape, and receives fuel, that is, hydrogen (H₂), from a manifold (not shown) to generate negative (−) current by an electrode reaction.

Here, the anode 110 is formed using nickel oxide (NiO) and yttria stabilized zirconia (YSZ). Nickel oxide (NiO) is reduced to the metal nickel by hydrogen (H₂) to exhibit electric conductivity and yttria stabilized zirconia (YSZ) exhibits ion conductivity as oxide.

Here, a weight ratio of nickel oxide (NiO) and the yttria stabilized zirconia (YSZ), which constitute the anode 110, may be for example 50:50 or 40:60, but is not particularly limited thereto.

The electrolyte 120 serves to transfer oxygen ions, which are generated in the cathode, to the anode 110, and may be formed to surround the outer circumference of the anode 110.

Here, the electrolyte 120 may be coated by a drying method, such as a plasma spray method, an electrochemical deposition method, a sputtering method, an ion beam method, an ion injection method, or the like, or a wetting method, such as a tape casting method, a spray coating method, a dip coating method, a screen printing method, a doctor blade method, or the like, and then sintered at 1300° C. to 1500° C., but is not particularly limited thereto.

Here, the electrolyte 120 may be formed by using yttria stabilized zirconia (YSZ), scandium stabilized zirconia (ScSZ), doped lanthanum gallate oxides (LSGM), but is not particularly limited thereto.

Meanwhile, the electrolyte 120 has low ion conductivity, with the result that voltage drop due to resistance polarization is small. Therefore, the electrolyte 120 is preferably formed as thinly as possible, but is not particularly limited thereto.

In addition, special care should be taken in which scratches are not generated, since a crossover phenomenon of directly reacting fuel (hydrogen) with air (oxygen) occurs when pores are generated in the electrolyte 120, resulting in a reduction in efficiency.

The cathode 130 receives air (oxygen) from the outside of oxidizing ambient to generate positive (+) current by an electrode reaction. The cathode 130 may be formed to surround the outer circumference of the electrolyte 120.

Here, the cathode 130 may be formed by coating Lanthanum Strontium Manganite ((La_{0.84} Sr_{0.16}) MnO₃) or the like, having high electric conductivity by a dry method and a wet method, similarly to the electrolyte 120, followed by sintering at 1200° C. to 1300° C.

Meanwhile, in the cathode 130, but not particularly limited, for example, air (oxygen) may be converted into oxygen ions by a catalytic action of lanthanum strontium manganite (LSM), lanthanum strontium cobalt ferrite (LSCF), or the like, and then transferred to the anode 110 via the electrolyte 120. However, the cathode 130 is not particularly limited thereto.

As shown in FIGS. 1 and 3, a first opening part 125 may be formed in the electrolyte 120 of the unit cell 100 according to the present invention to lengthily expose the anode 110 in a longitudinal direction, and a second opening part 135 corresponding to the first opening part 125 may be formed in the cathode 130.

Here, width and length of the first opening part 125 may be smaller than width and length of the second opening part 135, but are not particularly limited thereto.

In the present embodiment, the unit cell 100 has a structure in which the anode 110 disposed inside is lengthily exposed in a longitudinal direction by the above-described first opening part 125 and second opening part 135.

As described above, the electrolyte 120 is removed on the exposed anode 110, and thus, a barrier layer 115 (see, FIG. 3), which functions to prevent hydrogen (H₂) fuel inside the anode 110 from leaking to a portion where the electrolyte 120 is removed may be formed.

Here, a material having high density, such as stainless steel (SUS), may be used as the barrier layer 115, but is not particularly limited thereto.

In the present preferred embodiment, the connector 140 may be formed on the barrier layer 115, which is formed on the exposed anode 110, to transfer the negative (−) current generated in the anode 110 to the outside of the unit cell 100.

Here, the connector 140 is a member for collecting the negative (−) current generated in the anode 110, and thus, it needs to be made of an electrically conductive material. In the present preferred embodiment, the connector 140 may be formed by using lanthanum strontium cobalt oxides (LSC), doped lanthanum chromite, or the like, but is not particularly limited thereto.

The connector 140 may be formed to cover the barrier layer 115.

As such, as for the solid oxide fuel cell 200 according to the present preferred embodiment, the anode 110 is lengthily exposed in a longitudinal direction and the connector 140 is formed to cover the exposed anode 110, with the result that the connector 140 also can be lengthily formed in the longitudinal direction of the unit cell 100, as shown in FIG. 1. Therefore, an area for collecting current becomes widened, thereby improving current collection efficiency with respect to the negative (−) current generated in the anode 110.

The solid oxide fuel cell 200 according to the present preferred embodiment may include a first current collecting member 150 formed on the connector 140 to collect the negative (−) current generated in the anode 110 through the connector 140 and a second current collecting member 160 formed on a surface of the cathode 130 to collect the positive (+) current generated in the cathode 130.

Here, the first current collecting member 150 and the second current collecting member 160 made of metal, as shown in FIG. 2, may be in a strip type, a ribbon type, or a wire type, but the shape thereof is not particularly limited.

Here, the metal may be silver (Ag), but is not particularly limited. Any material that can have oxidation resistance at a high temperature of 800° C. and excellent electric conductivity may be applied as the metal.

The solid oxide fuel cell according to the present preferred embodiment may further include an insulating member 170 formed on the first current collecting member 150 to cover the first current collecting member, as shown in FIGS. 2 and 3.

Here, the insulating member 170 may be made using ceramics, but is not particularly limited thereto. That is, the insulating member 170 may be made of any insulation material having heat resistance so as not to be deformed and destroyed at a high temperature of 800° C.

The solid oxide fuel cell according to the preferred embodiment may further include a conductive member formed between the first current collecting member 150 and the connector 140 to reduce contact resistance as well as improve current collection efficiency.

For example, the conductive member may include a mesh type conductive member and a conductive paste, but is not particularly limited thereto.

That is, although not shown in the drawings, the conductive paste may be printed on the connector 140, the mesh type conductive member may be attached onto the conductive paste, and then the first current collecting member 150 may be attached thereonto.

Here, the conductive member may be made of metal. The metal may be silver (Ag), but is not particularly limited.

In addition, in the present preferred embodiment, the surface of the cathode 130 may be wrapped by a high-temperature oxidation-resistive metal mesh (not shown), and then the second current collecting member 160 may be formed on the metal mesh.

Here, a conductive material, for example, a metal paste may be applied between the surface of the cathode 130 and the metal mesh (not shown) in order to improve contact efficiency between the surface of the cathode 130 and the metal mesh (not shown). Here, the metal may be silver (Ag), but is not particularly limited thereto.

The solid oxide fuel cell 200 according to the present preferred embodiment may further include a fixing unit 180 integrating and fixing the connector 140 connected to the anode 110, the first current collecting member 150, the insulating member 170, and the second current collecting member 160 disposed on the cathode 130 with the unit cell.

In other words, as shown in FIGS. 2 and 3, the first current collecting member 150 and the second current collecting member 160 are disposed on the unit cell 100, the first current collecting member 150 is covered with the insulating member 170, and then the fixing unit 180 is wound around these so that these are fixed to the unit cell 100.

Here, a metal wire having conductivity may be used for the fixing unit 180. Here, the metal may be silver (Ag), but is not particularly limited.

Here, the fixing unit 180, as shown in FIG. 2, may be wound around the unit cell 100 and the first current collecting member 150 and the second current collecting member 160 disposed thereon in the longitudinal direction of the unit cell 100, but is not particularly limited thereto.

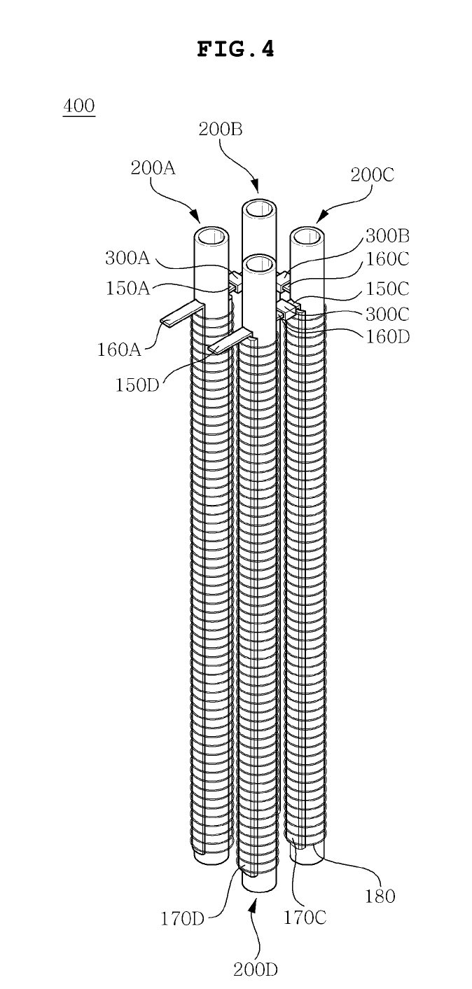

In the solid oxide fuel cell 200 according to the present preferred embodiment, based on FIG. 4, upper portions of the first current collecting member 150 and the second current collecting member 160, which are positioned at the upper portion of the unit cell, may be formed in a bent shape so that they are easily connected to another solid oxide fuel cell 200 in a subsequent process, but are not particularly limited thereto.

In addition, although not shown in the drawings, based on FIG. 4, the first current collecting member 150 and the second current collecting member 160 may formed in such a shape that they are lengthily protruded to a lower portion of the unit cell 100, and then bent.

Solid Oxide Fuel Cell Module

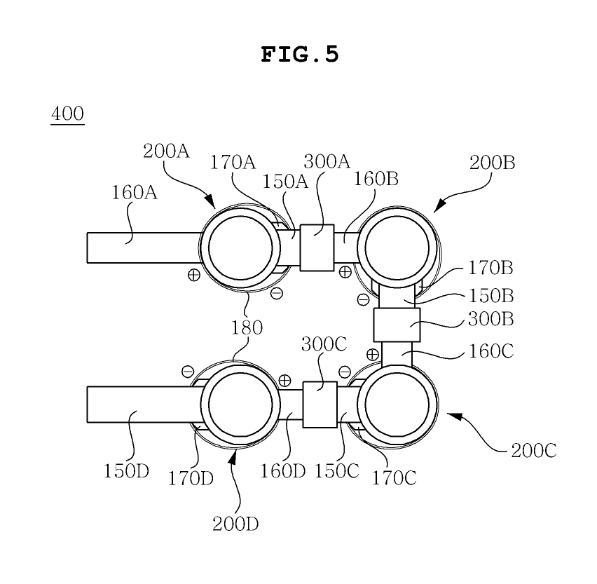

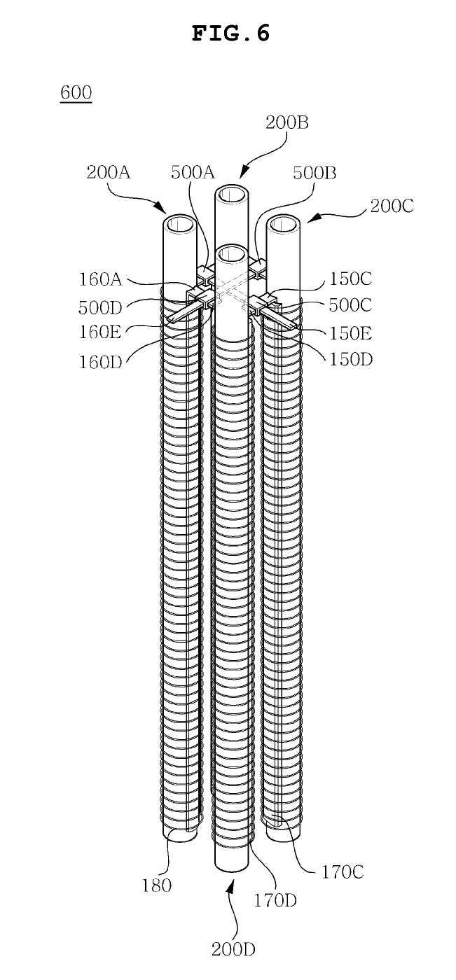

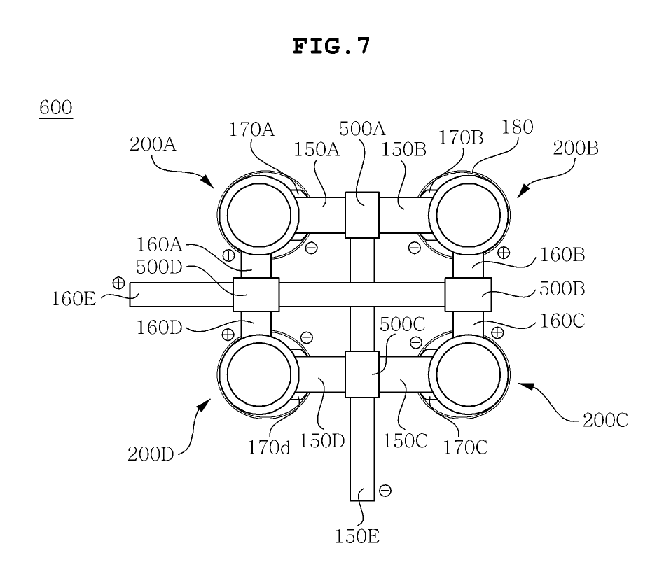

FIG. 4 is a perspective view showing a structure of a solid oxide fuel cell module in which solid oxide fuel cells are connected in series, according to another preferred embodiment of the present invention; FIG. 5 is a plan view showing the solid oxide fuel cell module shown in FIG. 4; FIG. 6 is a perspective view showing a structure of a solid oxide fuel cell module in which solid oxide fuel cells are connected in parallel, according to another preferred embodiment of the present invention; and FIG. 7 is a plan view showing the solid oxide fuel cell module shown in FIG. 6.

In the present preferred embodiment, descriptions of components corresponding to the above-described solid oxide fuel cell will be omitted, “A” to “D” will be additively marked onto initial reference numerals for a plurality of solid oxide fuel cells and respective components of the corresponding fuel cells, for distinction therebetween.

In addition, descriptions of components overlapping the above-described components will be omitted in the present preferred embodiment.

Referring to FIGS. 4 and 5, a solid oxide fuel cell module 400, in which a plurality of solid oxide fuel cells 200A, 200B, 200C, and 200D are connected in series, is disclosed.

Descriptions of respective solid oxide fuel cells 200A, 200B, 200C, and 200D are previously provided in the above-described solid oxide fuel cell, and therefore, will be omitted in the present preferred embodiment.

In general, the term “series connection” means that a positive (+) electrode and a negative (−) electrode are connected to each other, in other words, different types of electrodes are connected to each other.

Therefore, in the serial connection type solid oxide fuel cell module 400, a first current collecting member 150A of a first solid oxide fuel cell 200A, in which negative (−) current (generated in an anode 110) is collected, may be connected to a second current collecting member 160B of a second solid oxide fuel cell 200B, in which positive (+) current (generated in a cathode 130) is collected, by a first connecting member 300A, as shown in FIG. 5.

In the same manner, a first current collecting member 150B of the second solid oxide fuel cell 200B, in which negative (−) current is collected, may be connected to a second current collecting member 160C of a third solid oxide fuel cell 200C, in which positive (+) current is collected, by a second connecting member 300B.

In the same manner, a first current collecting member 150C of the third solid oxide fuel cell 200C, in which negative (−) current is collected, may be connected to a second current collecting member 160D of a fourth solid oxide fuel cell 200D, in which positive (+) current is collected, by a third connecting member 300C.

Through this connection, the first solid oxide fuel cell 200A, the second solid oxide fuel cell 200B, the third solid oxide fuel cell 200C, and the fourth solid oxide fuel cell 200D may be connected in series.

Further, a positive (+) terminal and a negative (−) terminal for the first to fourth solid oxide fuel cells 200A, 200B, 200C, and 200D connected in series may be the second current collecting member 160A of the first solid oxide fuel cell 200A and the first current collecting member 150D of the fourth solid oxide fuel cell 200D, respectively, as shown in FIG. 5.

Here, the first connecting member 300A, the second connecting member 300B, and the third connecting member 300C may be made by using a material having excellent oxidation resistance and electric conductivity, but are not particularly limited thereto, and for example, a non-conductive material is also usable.

In addition, referring to FIGS. 6 and 7, a solid oxide fuel cell module 600, in which a plurality of solid oxide fuel cells 200A, 200B, 200C, and 200D are connected in parallel, is disclosed.

In general, the term “parallel connection” means that a positive (+) electrode and a positive (+) electrode are connected to each other, and a negative (−) electrode and a negative (−) electrode are connected to each other, in other words, the same type of electrodes are connected to each other.

Therefore, in the parallel connection type solid oxide fuel cell module 600, the first current collecting member 150A of the first solid oxide fuel cell 200A, in which negative (−) current (generated in the anode 110) is collected, may be connected to the first current collecting member 150B of the second solid oxide fuel cell 200B, in which negative (−) current (generated in the anode 110) is collected, by a first connecting member 500A, as shown in FIG. 7.

In the same manner, the second current collecting member 160B of the second solid oxide fuel cell 200B, in which positive (+) current is collected, may be connected to the second current collecting member 160C of the third solid oxide fuel cell 200C, in which positive (+) current is collected, by a second connecting member 500B.

In like manner, the first current collecting member 150C of the third solid oxide fuel cell 200C, in which negative (−) current is collected, may be connected to the first current collecting member 150D of the fourth solid oxide fuel cell 200D, in which negative (−) current is collected, by a third connecting member 500C.

In like manner, the second current collecting member 160D of the fourth solid oxide fuel cell 200D, in which positive (+) current is collected, may be connected to the second current collecting member 160A of the first solid oxide fuel cell 200A, in which positive (+) current is collected, by the fourth connecting member 500D.

In addition, referring to FIG. 7, the solid oxide fuel cell module 600 of the present preferred embodiment may further include a first connection element 150E and a second connection element 160E. The first connection element 150E serves to connect the first connecting member 500A and the third connecting member 500C for connecting the first current collecting members in which negative (−) current is collected. The second connection element 160E serves to connect the second connecting member 500B and the fourth connecting member 500D for connecting the second current collecting members in which positive (+) current is collected.

Here, the first connection element 150E and the second connection element 160E need not to be contacted with each other.

Through this connection manner, the first solid oxide fuel cell 200A, the second solid oxide fuel cell 200B, the third solid oxide fuel cell 200C, the fourth solid oxide fuel cell 200D can be connected in parallel. A negative (−) terminal and a positive (+) terminal of the first to fourth solid oxide fuel cells 200A, 200B, 200C, and 200D connected in parallel may be the first connection element 150E and the second connection element 160E, respectively.

Here, the first connecting member 500A, the second connecting member 500B, the third connecting member 500C, and the fourth connecting member 500D may be made by using a material having excellent oxidation resistance and electric conductivity, but are not particularly limited thereto, and for example, a non-conductive material also is usable.

As described above, in the solid oxide fuel cells 400 and 600 according to the present preferred embodiment, the first current collecting members 150A, 150B, 150C, and 150D of collecting negative (−) current generated in the anode 110 and the second current collecting members 160A, 160B, 160C, and 160D of collecting positive (+) current generated in the cathode 130 are all exposed to the outside of the fuel cells, and thus, serial connection or parallel connection can be simply carried out by using the connecting members.

Further, in the present preferred embodiment takes a module using four solid oxide fuel cells as an example, but this is merely an example. It is recognizable to those skilled in the art that a module can be manufactured by connecting less or more solid oxide fuel cells according to the above-described manners.

As such, in the solid oxide fuel cell module according to the present preferred embodiment, the first current collecting members of collecting currents of anodes and the second current collecting members of collecting currents of anodes in the respective fuel cells are all exposed, and thus, the first current collecting members and the second current collecting members can be easily connected to each other outside.

The present invention can easily realize serial connection or parallel connection between unit cells since both the current collecting member of the anode and the current collecting member of the cathode are formed outside.

Further, the present invention can easily collect current of the anode from the outside, by removing a part of the cathode and a part of the electrolyte in longitudinal directions thereof in the unit cell, exposing a part of the anode in a longitudinal direction thereof, and forming a connector on the exposed anode.

Further, the present invention can improve current collection efficiency, by lengthily forming current collecting members for the anode and the cathode in a longitudinal direction of the unit cell.

Although the preferred embodiments of the present invention have been disclosed for illustrative purposes, they are for specifically explaining the present invention and thus a solid oxide fuel cell and a solid oxide fuel cell module according to the present invention are not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A solid oxide fuel cell, comprising:
a unit cell including an anode, an electrolyte formed to surround the outer circumference of the anode and having a first opening part exposing the anode in a longitudinal direction, a cathode formed to surround the outer circumference of the electrolyte and having a second opening part corresponding to the first opening part, and a connector formed to cover the first opening part;
a first current collecting member formed to be contacted with the connector to thereby collect current of the anode;
an insulating member formed to cover the first current collecting member;
a second current collecting member formed to be contacted with the cathode to thereby collect current of the cathode; and
a fixing unit integrating fixing the first current collecting member, the insulating member, and the second current collecting member with the unit cell.

2. The solid oxide fuel cell as set forth in claim 1, wherein the insulating member is made of ceramics.

3. The solid oxide fuel cell as set forth in claim 1, further comprising a barrier layer formed between the anode and the connector.

4. The solid oxide fuel cell as set forth in claim 3, wherein the barrier layer is made of stainless steel (SUS).

5. The solid oxide fuel cell as set forth in claim 1, wherein the first current collecting member and the second current collecting member are in a metal strip type.

6. The solid oxide fuel cell as set forth in claim 5, wherein the metal is silver (Ag).

7. The solid oxide fuel cell as set forth in claim 1, further comprising a mesh type conductive member and a conductive paste layer formed between the connector and the first current collecting member.

8. The solid oxide fuel cell as set forth in claim 1, further comprising a mesh type conductive member and a conductive paste layer formed between the cathode and the second current collecting member.

9. The solid oxide fuel cell as set forth in claim 1, wherein the fixing unit is a wire.

10. The solid oxide fuel cell as set forth in claim 9, wherein the wire is made of silver (Ag).

11. A solid oxide fuel cell module, comprising:
a plurality of unit cells each including an anode, an electrolyte formed to surround the outer circumference of the anode and having a first opening part exposing the anode in a longitudinal direction, a cathode formed to surround the outer circumference of the electrolyte and having a second opening part corresponding to the first opening part, and a connector formed to cover the first opening part;
a first current collecting member formed to be contacted with the connector to thereby collect current of the anode;
an insulating member formed to cover the first current collecting member;
a second current collecting member formed to be contacted with the cathode to thereby collect current of the cathode;
a fixing unit integrating and fixing the first current collecting member, the insulating member, and the second current collecting member with the unit cell; and
a connecting member connecting the plurality of unit cells.

12. The solid oxide fuel cell module as set forth in claim 11, wherein the connecting member connects a first current collecting member and a second current collecting member of one unit cell of the plurality of unit cells to a second current collecting member and a first current collecting member of another unit cell of the plurality of unit cells, respectively.

13. The solid oxide fuel cell module as set forth in claim 11, wherein the connecting member connects a first current collecting member and a second current collecting member of one unit cell of the plurality of unit cells to a first current collecting member and a second current collecting member of another unit cell of the plurality of unit cells, respectively.

14. The solid oxide fuel cell module as set forth in claim 11, wherein the insulating member is made of ceramics.

15. The solid oxide fuel cell module as set forth in claim 11, further comprising a barrier layer formed between the anode and the connector.

16. The solid oxide fuel cell module as set forth in claim 15, wherein the barrier layer is made of stainless steel (SUS).

17. The solid oxide fuel cell module as set forth in claim 11, wherein the first current collecting member and the second current collecting member are in a metal strip type.

18. The solid oxide fuel cell module as set forth in claim 17, wherein the metal is silver (Ag).

19. The solid oxide fuel cell module as set forth in claim 11, wherein the fixing unit is a wire.

20. The solid oxide fuel cell module as set forth in claim 19, wherein the wire is made of silver (Ag).
